(19) United States
(12) Patent Application Publication
(10) Pub. No.: US 2014/0375531 A1
(43) Pub. Date: Dec. 25, 2014

(54) METHOD OF ROVIDING TO THE USER AN IMAGE FROM THE SCREEN OF THE SMARTPHOME OR TABLET AT A WIDE ANGLE OF VIEW, AND A METHOD OF PROVIDING TO THE USER 3D SOUND IN VIRTUAL REALITY

(71) Applicants: Ray Latypov, Binghamton, NY (US); Nurali Latypov, Moscow (RU); Alfred Latypov, Binghamton, NY (US)

(72) Inventors: Ray Latypov, Binghamton, NY (US); Nurali Latypov, Moscow (RU); Alfred Latypov, Binghamton, NY (US)

(21) Appl. No.: 13/925,808

(22) Filed: Jun. 24, 2013

(51) Int. Cl. G02B 27/01; H04S 7/00

(52) U.S. Cl. CPC G02B 27/0172; H04S 7/304
USPC 345/8; 381/310

(57) ABSTRACT

A method of presenting the user with a picture from the screen of a smart phone or tablet at a wide angle of view, consisting in that fixing a smart phone or tablet on the head in front of user's eyes, mounting the smart phone screen in front of the user's eyes to the line of sight, providing an optical means for obtaining an image sharpness, displaying an image which is the one selected from the group consisting images, videos, virtual space, or other applications.

A method of providing sound to each of the user's ears in a virtual reality application, consisting in that mounting stereo headphones on the user's head, calculating a sound level provided for each of the user's ears so as the sound propagated and attenuated in a real space with the corresponding position and orientation of the user in regard to the sound source.

### FIELD OF THE INVENTION

The invention relates to new areas and methods of using smart phones, tablets and other gadgets, as well as interfaces, giving more natural possibilities to interact with applications and providing more opportunities for immersion of the user into generated three-dimensional space. A method and arrangement, allowing wide angle view of common flat image applications, such as text editors, watching videos etc., so not only limited to virtual reality applications. This is actually a new interface for controlling and using smart phones and tablets. The method provides a wide angle of view from the screen of a smart phone, gadget or tablet (over 70 degrees) using the screen of the device itself, and not an additional virtual reality display.

For simplicity below we use the expression “smart phone”, though not limited to them only, the invention is aimed at smart phones, tablets and similar devices.

BACKGROUND ART

Immersive virtual reality usually requires a display put on head, head orientation sensor, a computing device generating the virtual space or augmented reality. Depending on the user's angle of view, determined by the orientation sensor, a computer generates a part of the virtual space on which the user's eye is directed in a virtual space model to be displayed to the user. Moreover, generation of an image follows the rotation of user's head.

Description of the current state of virtual reality:

computers, graphic cards, sensors, head displays, applications—everything is on the market, but it is expensive and did not reach the mass market. Many people have never immersed into virtual space, even for a short time. Maximum what is available for the majority of people are 3D-stereo movies and computer games on consoles, computers, gadgets, smart phones, but usually without the immersing.

The angle of view on stationary screens is 30-40 degrees, and on handheld devices such as smart phones and tablets 10-30 degrees. The rest, relatively larger area around is usually not associated with interactive applications, which the user sees on the screen.

### DISCLOSURE OF THE INVENTION

The average distance from eyes to a gadget screen is 20-40 cm. This is the distance at which a human eye can usually normally focus on the image. If you hold a gadget closer to the eyes, one needs to use optics to ensure sharpness. Besides, in common use of smart phones and tablets an important feature of human vision is not used—binocular vision, allowing the human brain to form a single dimensional perception based on images from both eyes. The method according to the invention will allow perception of a dimensional image for the tablet screen without additional head displays of virtual reality and use of human binocular vision feature when using conventional devices. For a more complete advantage of such possibilities, in some cases it will be necessary to adapt common applications and create new ones in accordance with possibilities the present invention opens.

A method of modifying images of three-dimensional applications for common smart phones and tablets (a way to create applications for the new interface of using tablets) allows the user to see a three-dimensional image by using technical solutions described herein, wherein instead of one image two separate images are generated for the right and the left eye, with a special angle and point of view for each eye, providing a stereoscopic effect, and each image is displayed to each eye separately from the corresponding parts of the screen. Special optics are used to ensure image sharpness, as the screen is closer to the eyes than during normal use of tablets.

Users already have smart phones and tablets, applications with three-dimensional spaces, but there is no immersive virtual reality—missing is: a technical solution, a non-trivial way to provide immersion without use of expensive devices, but with the correct use of the laws of optics—display of the most screen of a smart phone to the eye; with a software solution—enabling stereo, use of user's peripheral vision.

High resolution screens have appeared only recently that can give a good picture, even with magnifying optics.

Screen resolution of modern gadgets has increased and reached 329 dpi in modern popular gadgets, and announced are new displays with resolution of 440 dpi LG, 460 dpi Toshiba. Such resolution already exceeds the required level for the user to view the screen at an average distance of one foot. Thought it allows acceptable image when used as a head display with optics allowing you to see a sharp image at a short distance and connection to interactive actions of human peripheral vision. To increase the angle of view one can use additional head display, which can allow viewing the application at a larger angle of view, though limiting the view of external environment, and thus can provide a feeling of immersion into a 3 dimensional space of applications. Typically such displays with orientation sensors available on the market cost more than the largest smart phone or tablet.

The described invention provides a possibility to use a smart phone or tablet as a head display. Moreover, many of these devices have built-in orientation sensors, that can be used in applications with immersion into three-dimensional space. To do this, a smart phone or a tablet is mounted on the head, directly in front of the eyes at a significantly shorter distance than they are usually designed to be used at, and an optical lens is placed between them, ensuring image sharpness on the screen. Thus, a smart phone or tablet or other similar devices simultaneously turn into head display. The angle of view of the image on the screen dramatically changes, providing a more complete inclusion of peripheral eyesight when viewing the application. The angle of viewing an application in average will be more than 70 degrees, and in some cases it can reach 100 degrees or more. At the same time, built-in smart phone or tablet orientation sensor, if available, can be used as an orientation sensor. In fact, by fixing a smart phone or tablet device on the head and using correct optical devices for the eyes we get a device for immersive virtual reality.

The above-mentioned devices in common use for interactive applications with three-dimensional space are usually controlled by hand. To see the space at a new angle the user turned the device with hands or ran his fingers across the touch screen. The invention provides a solution ensuring a more natural interface to view at a new angle in the virtual space: you just have to turn your head as in ordinary space in real life. Thus, freed hands can be used for a more natural manipulating objects of virtual space. For example, by tracking the movements of hands and fingers using the back-side camera of a smart phone or tablet.

In fact, this is a revolutionary new way to use these popular devices.

The proposed method and arrangement, wherein the screen and a computing unit (smart phone or tablet) are placed in front of the user's eyes on the line of sight, at a short distance, while between the screen and the eye an optical device is placed, that provides sharpness of the image on the screen to an eye on such a short distance. An optical device used may be lenses, contact lenses, Fresnel lenses and even some filters as appropriate.

It is not a wearable computer with head display as presented by others. This is a ready device, manufactured in millions of copies, which can be used as a computer you wear on your head, providing an image of immersion applications. It is a way to use the ready mass devices, which have not been previously intended to be used for this purpose.

A smart phone, screen and a computing device are placed in line with the eyes, but not more than 15 cm away from them. The ideal distance from eyes to a gadget screen is 5-10 cm. Distance plays an important role. Too long distance will increase leverage the gadget puts pressure on. In case of a long distance from the head it will be hard to keep on the head and inconvenient to use because of heaviness and gadget's moment of inertia when rotating the head. In addition, a wide angle of view on the application will not be achieved, and the left angle of view for the right eye and right angle of view for the left eye will be significantly limited.

A new type of using gadgets as a screen worn on the head will be optimal in use for applications with immersion into three-dimensional space, but not limited to them only.

The proposed method provides means of displaying image form the screen of a tablet, wherein a portion of pixels of the same user's screen is displayed only to the left eye, and another part only to the right eye, and the image can be generated so as to ensure stereo effect, that is, three-dimensional image.

It is useful to use a special divider or curtain, so that the right eye does not see the image generated for the left eye and vice versa, if such an image or part of it can get into its field of vision.

It is useful to generate and display a wider portion of the right side of the image for the right eye, and the wider part of the left image for the left eye, which will provide a more complete use of peripheral vision and provide a wider angle of view. It is very natural for human vision in ordinary space, for example, a nose that closes the left side of the space for the right eye and vice versa. At this, there is a part of the space seen by the both eyes, but from a little different places and in different ways, due to the distance between the eyes, which provides three-dimensional perception of volume-space and objects.

When using a smart phone, image or part of the image is displayed only to one eye.

Potential applications: an arrangement and method of using smartphones and tablets and similar devices can have very wide fields applications. For example, computer game with immersion, training and other applications with immersion, and many others.

Smart phones and tablets in hands is a satisfactory solution, confirmed by the popularity of these devices in the world. The small angle of view reflects physiological capabilities of the eye, that can see an image with the highest resolution in a limited angle of about one or few degrees. At the same time, for applications where it is better to have a wide angle of view, for example, an application with immersion into virtual space, and/or where one or both hands are needed to manipulate the objects, and/or where natural interface is needed—a possibility to view any direction in the virtual space by usual rotation of the head in this space—the way we described in the application will provide a better solution of the above issues.

In this application we rely on a wide range of smart phone like devices available on the market. At the same time we offer additional solutions to implement such devices in the future and improve their functionality.

### BRIEF DESCRIPTIONS OF THE DRAWINGS

The invention is explained with examples of embodiment illustrated with drawings.

FIG. 1 shows an embodiment of the tablet mounting on a headband for providing to user an image from tablet with wide field of view.

FIG. 2 shows an embodiment of the smart phone mounting on a baseball cap for providing to user an image from smart phone with wide field of view.

FIG. 3 shows an embodiment of the smart phone mounting with blind means for limiting peripheral vision.

FIG. 4 shows the possible layout of the eyes, the lens and the tablet screen (top view).

FIG. 5 shows the possible layout of the head, the lens and the tablet screen (top view).

FIG. 6 shows the possible layout of images for eyes and control buttons on the tablet screen.

FIG. 7 shows the embodiment of providing to the user the stereo sound for virtual reality applications, where 3D orientation sensor mount on the head.

FIG. 8 shows the possible layout of the head and real or virtual sound source (top view).

FIG. 9 shows the sample of embodiment of providing to the user the stereo sound for virtual reality applications, where 3D orientation sensor mount in the tablet.

### DESCRIPTIONS OF THE DRAWINGS

The invention is explained with examples of embodiment illustrated with drawings.

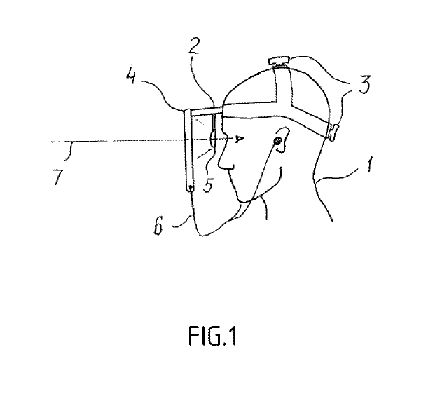

FIG. 1 shows an embodiment of the tablet 4 mounting on a headband as a means 2 to mounting the tablet on the head, with fitting means 3 of the headband, for providing to user 1 an image from tablet with wide field of view. The lens 5 as optical means is used to provide sharp image from the screen of the tablet on the short distance and providing wide field of view. The headphones 6 is used for providing to the user 1 mono or stereo sound. When tablet or smartphone on mounted on the user's head have built-in orientation sensor, the headphones 6 could be used for providing to the user 3D sound from virtual sound source in virtual environment. The eye (sight) horizontal line 7 on the figure shown to illustrate the sample of disposition of tablet and lens according eye and normal sight line when user look on a horizontal level.

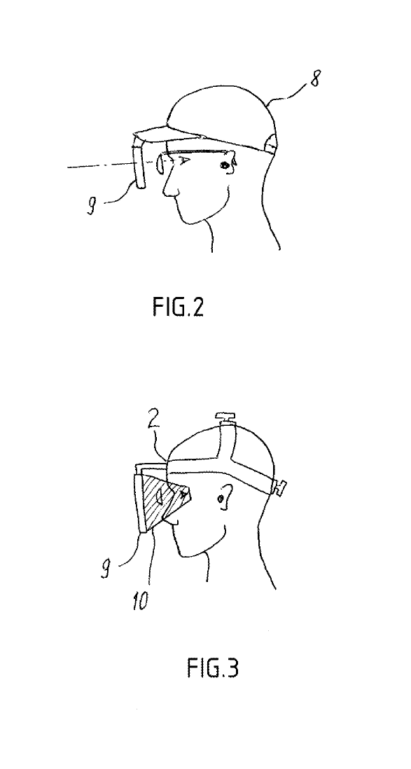

FIG. 2 shows an embodiment of the smart phone 9 mounting on a baseball cap 8 for providing to user an image from smart phone with wide field of view.

FIG. 3 shows an embodiment of the smart phone 9 mounting with blind means 10 for limiting peripheral vision.

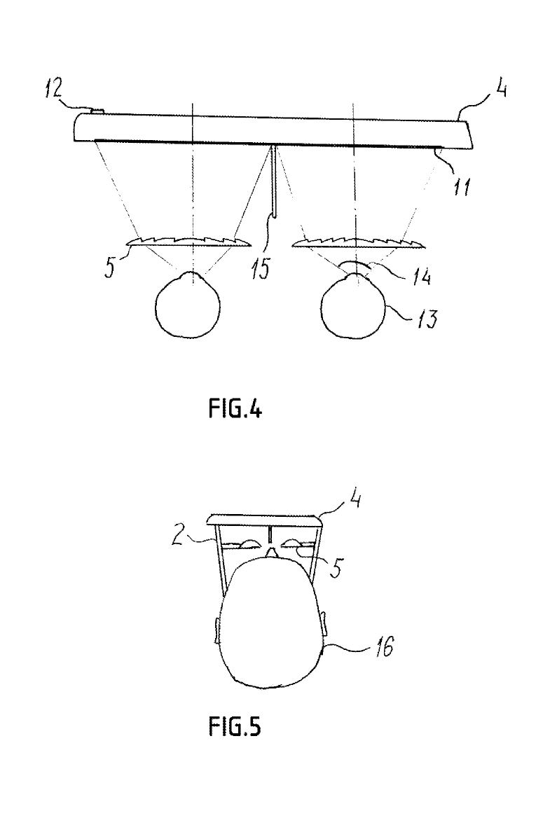

FIG. 4 shows the possible layout of the eyes 13, the lens 5 and the tablet screen 11 or smart phone (top view). On the drawing the optical means is shown as Fresnel lens 5. There is angle of view 14 shown on the FIG. 4, and how invention provide wide field of view even from the small screen of the smart phone. There is divider means 15 used for separation part of the image from screen for the right eye, and parts of the image for the left eye. There is external camera 12 of tablet or smart phone on the drawing. It could be used to recognition of hand and/or manipulator position and orientation according the head, by pattern recognition algorithms from the camera. The data of hand and for manipulator position and orientation could be used intuitively and naturally because the camera is mounted with the gadget on the user's head. It is like looking to hands or manipulator by eyes directly. That take difference from data recognition from cameras mounted on notebook monitors based on the table or cameras mounted in a means on the table. The head of the user is not bounded to that table and position and orientation data could be stable even user's head is moving. The camera mounted on the head will more precise reflect position and orientation according the head and give better control of virtual objects that user will see on the mounted screen with wide field of view.

FIG. 5 shows the possible layout of the head 16, the lens 5 and the tablet screen (top view). The means 2 is used to mount the smart phone or tablet 4 on the head. The FIG. 5 shows that optical means 5 could be placed on means 2, and means 2 could be used to limit the peripheral vision of the user.

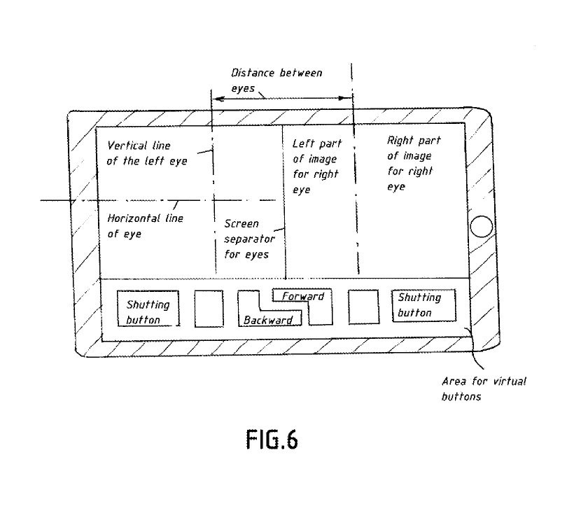

FIG. 6 shows the possible layout of images for eyes and control buttons on the tablet screen. The lower part of the screen could be used to control of the applications. The area for virtual buttons could be visible for eyes and limited for user's vision. The virtual buttons allocated to control application by users fingers. Such control could be duplicated by separate controllers, such as gamepads.

FIG. 7 shows the embodiment of providing to the user the stereo sound by stereo headphones 6 for virtual reality applications, where 3D orientation sensor 18 mount on the head. The virtual reality or other applications are generated by processor means 17.

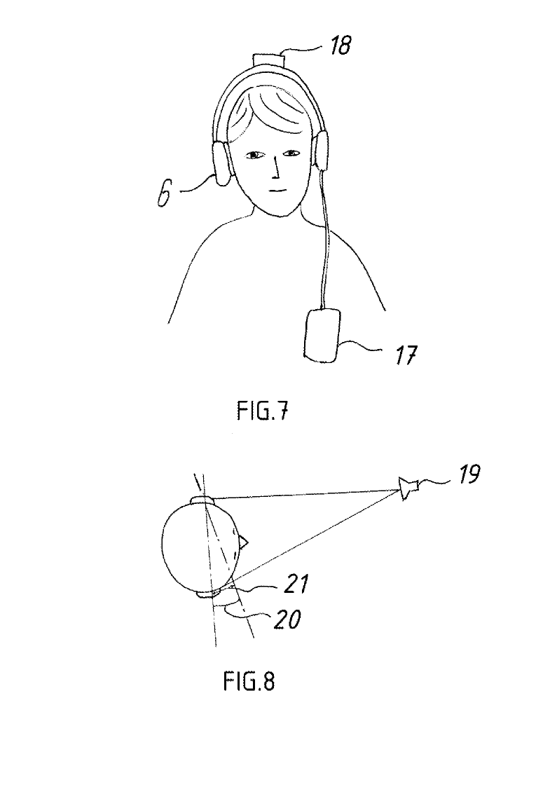

FIG. 8 shows the possible layout of the head and real or virtual sound source 19. The user's direct sight view forward and angle between source direction create angle 20 shown on the drawing. There is additional distance 21 should be taken by front of the sound to reach ear displaced farther than the other ear.

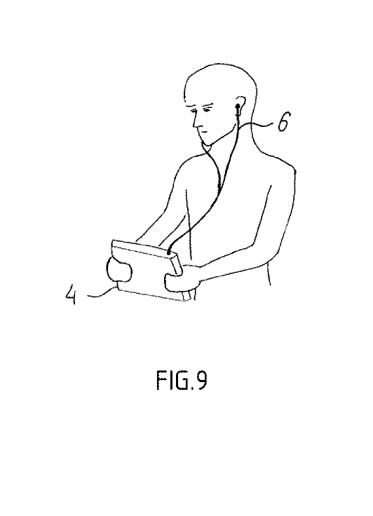

FIG. 9 shows the sample of embodiment of providing to the user the stereo sound by means 6 for virtual reality applications, where 3D orientation sensor mount in the tablet, but the tablet not mounted on the head. When the users eyes look directly to the tablet, and users head and tablet have same relative orientation, the data from tablet's orientation sensor could be used for immersive virtual reality application.

Here is a description of some important features disclosing details of the invention.

One screen for the two eyes with separate sectors for each eye.

A possibility to use part of the screen as a touch screen to control the application.

Customization of images: centers of the images according to the individual distance between eyes of users. Such adjustments could be made by a special application, using a touch screen or manipulator of a smart phone. It should be noted, often smart phones will be used for displaying an image for one of user's eyes, as the diagonal size of the screen is small 3-4.5 inches. Tablets with the screen size of 5 inches are more suitable for displaying images for the two eyes. Popular screen sizes of tablets are 7-10 inches. Average distance between eyes of an adult is 2.5 inches. So the distance for the tablet screen horizontally for use in accordance with our invention should be 5 inches or more.

It is useful to use film filters for screens to protect eyes and body from radiation, if needed.

The following features are very important for the invention:

focal length of the lens used, distance between the eye and the lens, distance between the eye and the screen, distance between the lens and the screen.

The distance between eyes and the screen of a tablet or smart phone should be short so that the leverage the gadget puts pressure on is not too long. Furthermore, the closer the distance the greater the angle on the image can be provided, the bigger inner corner can be ensured for left and right eyes. There is a common angle of view for the two eyes and angles of view for each eye, and right and left part of the angle of view for each eye (they may not be the same).

By selection of correct focal distance of the lens, its optical power and distance a focused sharp image can be ensured from the tablet or smart phone on the retina. At the same time a possibility to adjust the distance from the lens to the screen, and distance from an eye to the lens can provide image sharpness for a person with normal eyesight, with myopia, hyperopia, astigmatism, as well as when using conventional contact lenses or glasses.

Conventional lenses, Fresnel lenses, combinations thereof, and optionally a mirror or prism, a semitransparent mirror can be used as required optics. Prisms and mirrors can ensure realization of the invention, when placing a smart phone not at the direct optical axis of the eye.

A smart phone or a tablet can be mounted and/or fixed on the user's head using special fixtures so-called headbands that are used with conventional head-mounted displays too; it could also be fixed on a hat, baseball cap, on a cap peak or glasses as well as by other convenient ways. And required optical lenses could be mounted at those fixtures or could be implemented as a separate device e.g. as a kind of glasses. Peripheral part of smart phone's or tablet's screen may be kept open or covered with a special part of fixing device.

It is helpful to equip fixtures with adjustable elements ensuring secure positioning on the heads of different sizes.

Gadget holders could be structurally combined with optical system or implemented as separate modules as well: glasses, contact lenses and head-mounted gadget holder.

It is advantageous to implement the method of mounting and the fixture structure in a way that assures performing fine adjustments of smart phone or tab position on the fixture vertically and horizontally and an opportunity of shifting it to or from the eyes in order to ensure sharpness of image. Image sharpness could be adjusted by shifting the lens located between the eye and the screen accordingly relative to the eye along the line of sight at look into the distance.

Fine adjustments of positions of lenses and a gadget intended for user's eye have to ensure the maximum image sharpness at as large part of a screen as possible. The most important is to ensure the maximum image sharpness at the screen part that is the central one for each eye.

Of course, the user could hold a gadget with required optical system in his hands near his eyes for a short time yet it is inconvenient for long-term use.

Additional fine adjustments of the image could be performed using relevant software functionality when a smart phone or a tab is already fixed. These include shifting image upward, downward, to the right or to the left being performed according to physiological traits of a person and individually for each eye at that.

A counterbalance for a tablet could be advantageously used at the occipital side of the head mounting fixture in order to prevent it from slipping down being laden with weight of a tablet applied via lever formed due to certain distance from eye the tablet is fixed at. Additional batteries or parts of the device could be used to implement the counterbalance.

Well-known optics formulas allow visual image size to be calculated for any given focal length of a lens.

Wearable smart phone or tab and other methods or devices e.g. Virtusphere could be advantageously used concurrently for immersion into virtual reality.

External camera of the smart phone could be used as a sensor for determining of distance to objects marking limits of safety movement area for the user, tracking movements of user's hands and fingers, monitoring of position and orientation of user's pointing devices and for augmented reality applications.

When using contact lenses according to the invention an ambience image will become diffused after smart phone with its fixture is dismounted from the head. Compensating glasses that facilitate normal vision could be temporarily used with contact lenses in that case to ensure sharp image of the ambience.

The invention provides for immersive applications of new kinds to be created for smart phones and tablets making use of features of the new interface.

Augmented reality applications according to the invention will be used by millions of actual users owning devices that might be used more comprehensively and deliver immersive experience.

The majority of smart phones and tablets are equipped with cameras on their outside. Images of ambience and user's hands being produced by those cameras could be used for creation of augmented reality applications.

It is helpful to produce stereo images of real world (3D virtual reality) in the form of separate pictures intended for each eye individually that are being generated by computing device.

It is helpful to use optics to assure sharpness of images positioned at relatively small distance from the user's face.

If smart phone's or tablet's touch screen or a part of it is inaccessible it would be advantageous to use additional devices to control applications being run on smart phones or tablets. Wired or wireless pointing devices, keypads, mice, joysticks, gamepads etc. could be advantageously used to control applications.

Backside camera of a gadget could be used for discerning of location of user's arms and markers of pointing device, position and orientation of the gadget itself within a space, in relation to the space or markers located in the space.

Stereo headphones could be advantageously used with a smart phone or tablet to deliver three-dimensional sound to a user enabling him to discern intuitively the location of sound(s) source within 3D space being generated.

While the same screen is used for both eyes the images intended for each eye individually are being displayed at different parts of the screen.

One screen could be used for one eye if its size is so small that projection of images being displayed on it for both eyes is unreasonable without auxiliary optics being additionally used with ordinary magnifiers. With the average human eye spacing of 2,5 inches smart phone screens of horizontally size e.g. less than 3 inches ensure more comprehensive opportunities for displaying left part of the image for the right eye and right part of the image for the left one.

The minimal recommended size of a screen intended for both eyes equals to double spacing of human eyes pupil centers at normal look into the distance. The optimal screen size is the one allowing a space allotted for image right part intended for the right eye to be greater that the left part of the screen intended for the right eye. In that case peripheral vision that plays significant role in everyday life and in immersive applications as well will be used more comprehensively.

The residual part of the screen outside the application window, external wired or wireless pointing device, touch screen of buttons located at side face or backside of a gadget can be used for application control that could be based on recognition of patterns at the images being produced by a camera located at screen backside (e.g. movements of hands or special markers).

An optical system can be made adjustable to ensure image sharpness for user's eye. It can be achieved by means of conventional glasses or contact lenses as well as by adjusting of optical system in order to compensate abnormalities of vision.

The same screen can be used for both eyes in a time-sharing mode arranged with electronic shutters that close the screen for one eye while image intended for another eye is being displayed and vice versa.

Computing device can be structurally separated from the screen while being connected to it with wires or by wireless technology. In that case mounting holder of a lightweight screen positioned in front of eyes can be lighten and computing device can be used as a counterbalance at the back side of the user's head.

It is advantageous to manufacture display with a screen as a structurally separated unit specially designed according to the invention. In that case smart phone that delivers images could be positioned not at the eye level but e.g. at the occiput as a screen counterbalance or even in a pocket or simply in hand. Holding smart phone in hands user would be able to use its touch screen and buttons that would simplify control of applications.

In case of detached structure of smart phone consisting of a screen and the other part of the device it would be advantageous to combine the screen with means for orientation and positioning determination. Computing device placing is not important in that case.

Smart phones and pads equipped with 2 video cameras on their outside could be advantageously used according to our invention. In that case it would be possible to use applications with advanced reality features that superimpose artificially created 3D objects with 3D video image instead of one flat video image that is being used currently.

An image separating device could be used if two particular images intended for each respective eye are being used. It could be implemented in the form of a shutter that prevents images intended for one eye to be seen by the other eye. Stereo effect will be created and the user will see stereoscopic picture.

A lot of settings can be performed via respective software including number of pixels being displayed, screen size intended for each individual eye, size of application window displayed, distance between central parts of screens being displayed that should correspond to the distance between the user's eyes, and display brightness. Those adjustments can be performed in advance by setting appropriate preset values and on-the-fly as well when a gadget is already on the user's head. In the latter case a special adjustment part of application or a separate customization program could be used.

Smart phones and pads being used according to the invention create and opportunity of more comprehensive usage of immersive applications providing users with an experience of being surrounded by a virtual space.

The method according to the invention decreases percentage of real world images being displayed wherewith to increase percentage of images being created by a pad and displayed to user. While viewing an image on 10 inches pad from the distance of 16 inches from eyes the angular field of view equals approximately to 30×20 degrees. And the full natural angular FOV of a human is about 180 degrees horizontally for two eyes including peripheral vision (for one eye it equals to 60 and 90 degrees in the inside and outside directions respectively, and 130 degrees vertically).

Some definitions and important features:

The space an eye is able to see when line of sight is directed to a fixed point is referred to as field of view (FOV). The borders of the FOV are measured along the perimeter. The FOV borders for colourless objects are located at 70 degrees downward, 60 degrees upward and 60 and 90 degrees at inside and outside directions respectively. FOVs of both human eyes coincide partially that is of great importance for perception of space depth.

Binocular vision is the vision assured by two eyes. When a person with normal vision looks at a certain object he doesn't have a perception of the object is duplicated in spite of two images that are being separately produced at retinas of each eye. Images of every point of that object is located at so-called corresponding or respective parts of two retinas and two images are being merged in one in human's perception.

Even if peripheral part of a screen is not ideally sharp due to imperfection of intermediate optical system the user will have a possibility to turn his head so that the object of interest will be located nearer to the center of the screen i.e. within the maximum sharp part of it. As a matter of fact, people do the same in real life. In that case the sharp part of the screen will be displayed more clearly and in addition it will be transferred to the part of retina that has higher resolution of image recognition.

High resolution level of gadgets screens will make it possible to use them as head-mounted displays. E.g., Retina displays of iPhone and iPad have resolution of 329 dpi thus create no discomfort related to large pixels when being viewed through magnifying glass.

The central pit of human retina (fovea) that has angular size of about 1.3° contains only cones while peripheral part of retina contains cones and rods as well. The more is the distance from the eye center the less is the number of cones per surface unit of retina. The rods are distributed within the peripheral part of retina more evenly but there exists a minimum of their density at the angle distance about 10° from the fovea.

A method of delivering three-dimensional sound to a user and applications based on 3D-sound.

3D sound is properly calculated volumetric sound fed into stereo headphones. This sound enables user to locate a sound source in virtual space i.e. to discern intuitively the location of a sound source.

It is possible to create applications based solely on sound and on opportunity of discerning the location of sound source(s) that 3D-sound assures.

Special features of binaural hearing are being used not comprehensively in modern applications like computer games.

Even the fact that some games partially support 3D-sound yields minimal effect as the computers and game consoles being used as well as stereo sound or Dolby Surround systems are placed stationary. Stereo headphones also give no proper effect at that. The key for 3D-sound effectiveness is the usage of orientation sensors located at the user's head. That enables orientation of the user's head in the space to be discerned and that information to be used for properly playing back of a sound individually for each ear of the user that corresponds to the sound source location in the virtual space.

Sound engine according to the invention has to calculate sound levels from a sound source located at a certain point of virtual space model on the grounds of the source directivity when it is reasonable, coordinates and orientation of the user's head in that space. Information about head orientation and position should be used in a way ensuring sound levels dependability from distance to the sound source, appropriate delay of sound entering each ear, taking into account ear shadowing due to head orientation when the ear is not at the line directed to the sound source, diffraction of sound and its spectrum as well. Sounds of various frequencies are shadowed by head in different ways and differently perceived due to auricle curvature.

It is advantageous to use appropriate means for discerning user's head orientation in real space and relevant orientation of it in the virtual space. There exists an opportunity of delivering 3D-sound to ears from the source located in virtual space in a way that ensures user to discern location of the sound source. And applications according to the invention that use 3-D sound may either include displaying of 3D-images for the user or not support any visualization and be based solely on the sound at that.

The method used to binaural sound delivering to the user includes modification of original sound for each user's ear, implementation of relevant calculations for the sound to be properly delivered to each ear with different volume levels, calculated time delay of sound wave front, implementation of sound filters for various sound pitches in order to ensure natural perception of the sound and opportunity of its source localization in the virtual space.

The method of creation of applications implementing 3D virtual space that ensures sound source to be naturally localized by the user in a virtual space. Human hearing sense and physiological traits, specifics of sound propagation within the space and user's head are to be utilized at most for that purpose. Applications created according to the invention will ensure localization of the sound source being performed by application users on the basis of aural reception using natural congenital mechanism that is being used by a person the birth and according to that person experience.

The distance to the sound source depends on user's head location and orientation in relation to the source of a sound. E.g., the nearer is the sound source located to the ear the louder is the sound. The greater is the difference in distance from the sound source to each ear the greater is the delay of sound wave front entering the farther ear. The loudness of a sound depends not only on the distance to the sound source it is additionally decreased in case the sound source is shadowed by a head and it should also be used to properly calculate sound levels for each ear individually. And the effect of shadowing is not the same for different sound frequencies at that.

The method ensures an opportunity of creation games based solely on sounds or the ones where visualization is not used from time to time. It will be possible to play on the basis of aural reception. Hearing a sound user can localize its source and take appropriate actions depending on the application objectives e.g. approach nearer to the source or retreat from it or shoot at it.

The figure illustrates user's head and difference in distances to the ears.

The average distance between human ears equals to 6 inches.

Time delay and volume of a sound are two components of binaural hearing that have been not comprehensively implemented yet in soft and hardware. Time delay has not been implemented in direct sound and other software applications while volume of a sound is partially implemented in some sound engines and libraries. Nevertheless those features could not be implemented comprehensively without usage of 3D-orientation sensors as neither stereo sound equipment nor even surround gives any opportunities of accurately positioning of sound source at all directions.

One of the possibilities that could be implemented is the usage of modern smartphones and tablets equipped with rotation sensors. If stereo headphones are connected to those devices and correctly calculated sound is delivered according to the invention it becomes possible to use rotation sensor of a smartphone instead of a head-mounted one as the user looks at it perpendicularly to the screen when holding it in his hands. That in turn means the user's head and the smartphone are rotating synchronously. In case a smartphone is mounted on the user's head according to this invention the device and the user's head are simply bound together.

The method of creating and functioning of computer applications in which 3D-sound plays the leading part. In order to successfully complete the task specified in the application the user has to discern and constantly monitor location of 3D-sound source in a simulated 3D-space. This is performed on the basis of 3D-sound being delivered to the user while 3D-space might not be visualized at that.

Sound signals being perceived by the left and the right ear are significantly different due to spatial separation of sound receivers (auricles), shadowing effect of the head and torso and diffraction effects. That makes possible sound source localization within a space to be performed on the grounds of the following three physical factors:

a) time factor (Interaural Time Difference—ITD)—resulting from nonconcurrency of the same phases of sound entering left and right ears;

b) intensity factor (Interaural Intensity Difference—IID)—resulting from difference in intensity levels of sound wave due to diffraction of it around a head and acoustic shadow formation at the side opposite to the sound source.

c) spectral factor resulted from difference in sound spectrum perceived by left and right ears due to different shielding effect of head and auricles on low frequency and high frequency components of a complex sound.

3d-applications using three-dimensional sound according to the invention could be used in computer games, training applications intended for military and police staff etc.

What is claimed is:

1. A method of presenting the user with a picture from the screen of a smart phone or tablet at a wide angle of view, consisting in that
fixing a smart phone or tablet on the head in front of user's eyes,
mounting the smart phone screen in front of the user's eyes to the line of sight at a distance of 4-12 centimeters from the eyes to provide a wide angle of view at 70-120 degrees,
providing an optical means for obtaining an image sharpness between the smart phone screen and at least one of user's eyes,
displaying an image on the screen of smart phone or tablet, which is the one selected from the group consisting of individual images, videos, virtual space, or other applications,
providing the user with a means for controlling the smartphone or tablet.

2. The method according to claim 1, wherein at least one framed optical lens is using as optical means.

3. The method according to claim 2, wherein providing possibility for moving at least one framed optical lens along the optical axis of the screen-eyes and perpendicular to that axis.

4. The method according to claim 1 or 2, wherein the optical lens is a Fresnel lens.

5. The method according to claim 1, wherein said optical means comprised two optical lenses.

6. The method according to claim 1 or 3, wherein providing possibility of changing the distance between each of the optical lenses and the screen of smart phone or tablet according to eyesight parameters of each of the user's eyes to adjust picture sharpness.

7. The method according to claim 1 or 3, wherein providing the possibility of changing the distance between the lenses according to distance between the centers of the user's eyes.

8. The method according to claim 1, wherein setting a divider between the user's eyes insuring separation of the image on the device's screen into two parts, so that a part of the image on the screen of a smart phone in front of the right eye is displayed in the right eye, and the other part of the image on the screen of a smart phone in front of the left eye is displayed in the left eye, so that the image is perceived by the left and the right eye jointly in the brain generating a single three-dimensional stereo image.

9. The method according to claim 1, wherein position of user's hand(s) and/or manipulator in the user's hand(s) is used for controlling the smart phone or tablet, the image of which is fixed by back-side camera(s) of the smart phone or tablet and using image recognition algorithms their position and orientation are defined; using the acquired information to ensure control by the smart phone or tablet.

10. A method of providing sound to each of the user's ears in a virtual reality application, consisting in that
mounting stereo headphones on the user's head,
immersing the user into the virtual reality, represented by at least one sound source, provided to the user by stereo headphones,
determining position and orientation of the user's head in the virtual space,
determining a distance at least one sound source in virtual space to each of the user's ears,
calculating a sound level provided for each of the user's ears so as the sound propagated and attenuated in a real space with the corresponding position and orientation of the user in regard to the sound source.

11. The method according to claim 10, wherein calculating the difference for arrival time of sound front to the left and right ears and providing a sound front to each ear taking into account said time difference (delay).

12. The method according to claim 10, wherein changing time arrival in that the sound level and arrival time of the sound front is changed according to the user's head circumference.

13. The method according to claim 10, wherein changing the sound level and arrival time of the sound front according to spectral characteristics of sound.

14. The method according to claims 10-13, wherein displaying virtual environment together with sound to the user on a smart phone or tablet.

15. The method according to claims 10-13, wherein displaying virtual environment together with sound to the user with a wide angle of view from the screen of a smart phone or tablet mounted on the head.
